(19) United States
(12) Patent Application Publication
(10) Pub. No.: US 2008/0067933 A1
(43) Pub. Date: Mar. 20, 2008

(54) ORGANIC LIGHT EMITTING DISPLAY

(75) Inventors: CHAN HEE WANG, YONGIN-SI (KR); YOON CHAN OH, YONGIN-SI (KR); DAE HO LIM, YONGIN-SI (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., SUWON-SI (KR)

(21) Appl. No.: 11/670,330

(22) Filed: Feb. 1, 2007

(30) Foreign Application Priority Data
Sep. 20, 2006 (KR) 10-2006-0091231

(51) Int. Cl. H01J 1/62; H01J 63/04

(52) U.S. Cl. 313/512

(57) ABSTRACT

Disclosed is an organic light emitting display device in which a display panel is accommodated in a support frame. The organic light emitting display device includes the display panel, the support frame and an intervening frame. The display panel includes a first substrate in which an organic light emitting device is formed, a second substrate opposing the first substrate, and an encapsulation material formed between the first substrate and the second substrate. The support frame includes a lower surface and a plurality of side walls extending from the edges of the lower surface. The lower surface and the side walls define a space in which the display panel is accommodated. The intervening frame is interposed between the side walls of the support frame and the display panel.

### CROSS-REFERENCE TO RELATED APPLICATIONS

This application claims the benefit of Korean Patent Application No. 10-2006-0091231, filed on Sep. 20, 2006, in the Korean Intellectual Property Office, the disclosure of which is incorporated herein by reference in its entirety. This application is related to and incorporates herein by reference the entire contents of the following concurrently filed applications:

| | | Filing | Application |
|---|---|---|---|
| Title | Atty. Docket No. | Date | No. |
| ORGANIC LIGHT-EMITTING | SDISHN.100AUS | | |
| DISPLAY DEVICE | | | |
| ORGANIC LIGHT | SDISHN.101AUS | | |
| EMITTING DISPLAY DEVICE | | | |

### BACKGROUND

1. Field of the Invention

The present invention relates to an organic light emitting display device, and more particularly, to an organic light emitting display in which a display panel is accommodated in a frame.

2. Discussion of Related Art

In general, a display panel of an organic light emitting display device includes a substrate in which an array of light emitting pixels is formed and a container or a substrate for encapsulating the array.

The array is connected between a plurality of scan lines and a plurality of data lines in the form of a matrix and includes a plurality of pixels having an anode electrode, a cathode electrode, and an organic thin film layer. If a predetermined voltage is applied to the anode electrode and the cathode electrode, a hole injected through the anode electrode and an electron injected through the cathode electrode are recombined on a light emitting layer, and light is emitted by energy difference generated in the process.

In the display panel of the organic light emitting display device, since the substrate is generally formed of glass, it may be vulnerable to an impact. Therefore, the display panel is mounted to a bezel formed of a metal to be supported and protected. However, since as the size and thickness of a small-sized portable device such as a mobile phone gradually decreases, the reduction of the thickness of the display panel or substrate is desired, which may cause the increase of fragility.

The discussion in this section is to provide general background information, and does not constitute an admission of prior art.

### SUMMARY

An aspect of the invention provides an organic light emitting display device, which may comprises: a display panel comprising a first substrate, a second substrate opposing the first substrate, an array of organic light emitting pixels interposed between the first and second substrates, and an encapsulation material surrounding the array and interconnecting the first substrate and the second substrate, wherein the display panel comprises a first side; a support frame comprising a lower plate and a plurality of side walls extending from edges of the lower plate, the lower plate and the plurality of side walls defining a space in which the display panel is accommodated, wherein the plurality of side walls comprises a first side wall opposing the first side of the display panel, wherein the first side wall comprises a first wall portion, a second wall portion and a connecting portion interconnecting the first and second wall portions, and wherein the first wall portion is interposed between the second wall portion and the first side of the display panel; and an intervening frame comprising a first intervening portion interposed between the first wall portion of the first side wall and the first side of the display panel.

In the foregoing device, the first intervening portion may contact both the first wall portion of the first side wall and the first side of the display panel. The intervening frame may be bonded to the support frame. The display panel may further comprise a second side, wherein the plurality of side walls of the support frame may further comprise a second side wall, and wherein the intervening frame may further comprise a second intervening portion which is interposed between the second side of the display panel and the second side wall of the support frame. The display panel may further comprise a third side, wherein the plurality of side walls of the support frame may further comprise a third side wall, and wherein the intervening frame may further comprise a third intervening portion which is interposed between the third side of the display panel and the third side wall of the support frame. The first intervening portion may be connected to the second intervening portion, and wherein the first intervening portion may be connected to the third intervening portion. The second intervening portion may comprise two ends opposite to each other, and wherein one end may be connected to the first intervening portion and the other end may be a free end.

Still in the foregoing device, the first wall portion comprises a first surface opposing the second wall portion, wherein the second wall portion comprises a second surface opposing the first wall portion, and wherein at least a portion of the first surface may contact the second surface. The first wall portion comprises a first surface opposing the second wall portion, wherein the second wall portion comprises a second surface opposing the first wall portion, and wherein the first surface may not contact the second surface. The first wall portion may be directly connected to the lower plate. The second wall portion may be directly connected to the lower plate. The intervening frame may comprise a material selected from the group consisting of LCP, ABS, PCABS and PC. The support frame may comprise a material selected from the group consisting of metal and polymeric resin. The encapsulation material may comprise a frit. The first intervening portion of the intervening frame may contact the frit. The display panel comprises a surface opposing the lower plate, and wherein the surface may be bonded to the lower plate.

An aspect of the invention provides a method of making an organic light emitting display device, which may comprises: providing a support frame, wherein the support frame comprises a lower plate and a plurality of side walls extending from edges of the lower plate, the lower plate and the plurality of side walls defining a space, wherein the plurality of side walls comprises a first side wall opposing the first side of the display panel, and wherein the first side wall comprises a first wall portion, a second wall portion and a connecting portion interconnecting the first and second wall portions; arranging a display panel so as to be accommodated in the space of the support frame, wherein the display panel comprises a first substrate, a second substrate opposing the first substrate, an array of organic light emitting pixels interposed between the first and second substrates, and an encapsulation material surrounding the array and interconnecting the first substrate and the second substrate, and wherein the display panel is accommodated in the space of the support frame; and interposing an intervening frame between the display panel and the plurality of side walls.

In the foregoing method, interposing may comprise forming the intervening frame on at least one of the plurality of the side walls and arranging the support frame and the display panel such that the intervening frame is interposed between the display panel and the plurality of side walls. Forming may comprise placing a curable material on the at least one of the plurality of side walls and curing the curable material. The display panel comprises a side, and wherein the intervening frame may comprise a portion which contacts both the side of the display panel and one of the plurality of side walls.

Still another aspect of the present invention provides an organic light emitting display including a bezel which can effectively protect a side surface of a display panel from an impact.

Yet another aspect of the present invention provides an organic light emitting display including a bezel which can effectively protect the lower surface of a display panel from an impact.

A further aspect of the present invention provides an organic light emitting display comprising: a display panel including a first substrate in which an organic light emitting device is formed, a second substrate opposed to the first substrate, and an encapsulation material formed between the first substrate and the second substrate; a bezel including a lower surface and a plurality of side walls extending from the edges of the lower surface, the lower surface and the side walls defining a space in which the display panel is accommodated; and a mold frame interposed between the side walls of the bezel and the display panel.

### BRIEF DESCRIPTION OF THE DRAWINGS

These and other aspects and advantages of the invention will become apparent and more readily appreciated from the following description of embodiments, taken in conjunction with the accompanying drawings of which:

FIG. 1 is an exploded perspective view for explaining an organic light emitting display according to the present invention;

FIG. 2 is a perspective view for explaining a bezel according to an embodiment of the present invention;

FIG. 3 is a cross-sectional view taken along line A1-A2 of FIG. 2;

FIG. 4 is a perspective view for explaining a bezel according to an embodiment of the present invention;

FIG. 5 is a cross-sectional view taken along line B1-B2 of FIG. 4;

FIG. 6 is a perspective view for explaining a bezel according to an embodiment of the present invention;

FIGS. 7a to 7f are partial cross-sectional views for explaining a bezel of a dual wall structure; and

FIGS. 8a to 8c are graphs showing stress measuring results through fall simulations.

### DETAILED DESCRIPTION OF EMBODIMENTS

Hereinafter, various embodiments of the present invention will be described with reference to the accompanying drawings. The embodiments are provided so that those skilled in the art can sufficiently understand aspects of the present invention, but the embodiments may be modified in various forms which fall within the scope of the present invention.

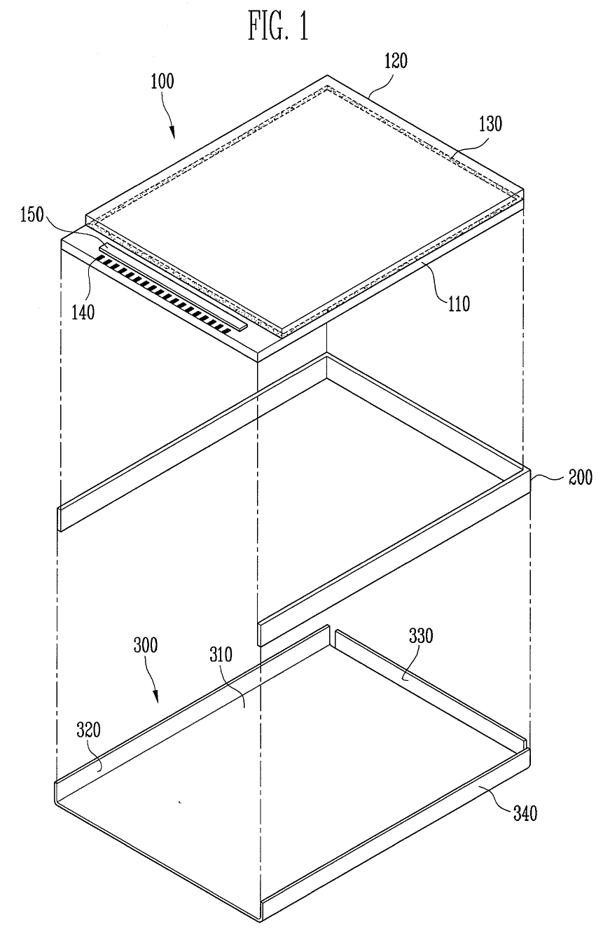

FIG. 1 is an exploded perspective view for explaining an organic light emitting display according to an embodiment of the present invention. The organic light emitting display includes a display panel 100, a bezel or support frame accommodating the display panel 100, and a mold frame or intervening frame 200 interposed between the bezel 300 and the display panel 100.

The display panel 100 includes a support substrate 110 in which an organic light emitting device or an array of organic light emitting pixels is formed, an encapsulating substrate 120 opposed to the support substrate 110, and an encapsulation material 130 formed between the support substrate 110 and the encapsulating substrate 120. The support substrate 110 includes a pixel area and a non-pixel area. In the pixel area, the array connected to between a scan line and a data line is formed in the form of a matrix to constitute pixels. In the non-pixel area, a scan line and a data line which extend from the scan line and the data line of the pixel area, a power source voltage supply line for the operation of the organic light emitting device, and a drive unit 150 processing signals provided through a pad section 140 from outside and supplying the signals to the scan line and the data line. An FPC (flexible printed circuit) (not shown) is connected to the pad section 140 and signals (a power source voltage, a scan signal, a data signal, etc.) are input through the FPC from outside.

In certain embodiments, the organic light emitting device or the array includes an anode electrode and a cathode electrode and an organic thin film layer formed between the anode electrode and the cathode electrode. The organic thin film layer has a structure in which a hole transport layer, an organic light emitting layer, and an electron transportation layer are stacked and can further include a hole injection layer and an electron injection layer. In addition, the organic light emitting device can further include a switching transistor for controlling the operation of the organic light emitting device and a capacitor for maintaining signals.

The encapsulating substrate 120 is formed of a transparent material such as glass and is opposed to the support substrate 110 to encapsulate the organic light emitting device. The encapsulation material is provided to prevent penetration of oxygen or moisture by encapsulating the organic light emitting device and is formed between the support substrate 110 and the encapsulating substrate 120 so as to surround the organic light emitting device. The support substrate 110 and the encapsulating substrate 120 are interconnected by the encapsulation material 130. The encapsulation material 130 is formed of an inorganic encapsulation material or an organic encapsulation material such as a frit including at least one kind of transition metal dopant.

The bezel or support frame 300 includes a lower surface 310 and a plurality of side walls 320, 330, and 340 extending from the edges of the lower surface or plate 310. An accommodation space is formed by the lower surface 310 and the side walls 320, 330, and 340 and the display panel 100 is accommodated so that the support substrate 110 opposes to the lower surface 310 and a side surface opposes to the side walls 320, 330, and 340. Then, the support substrate 110 can be attached to the lower surface 310 by a bonding tape or an adhesive. The bezel 300 can be manufactured by bending a metal plate or by extruding a plastic etc. The side walls 320, 330, and 340 may be connected to each other to be integrally formed or may be separated from each other and then are assembled for the manufacturing convenience.

The mold frame or intervening frame 200 is interposed between the side walls 320, 330, and 340 of the bezel 300 and the display panel 100 and, in certain embodiments, can be formed of a plastic, an LCP, an ABS, a PCABS, a PC, or the like which may have a high impact absorbing rate. For example, the mold frame 200 can be manufactured so as to have a U-shape corresponding to the three side walls 320, 330, and 340 of the bezel 300 and can has a rectangular or circular cross-section. Further, the bezel 300 and the mold frame 200 can be integrally manufactured by using an insert molding method.

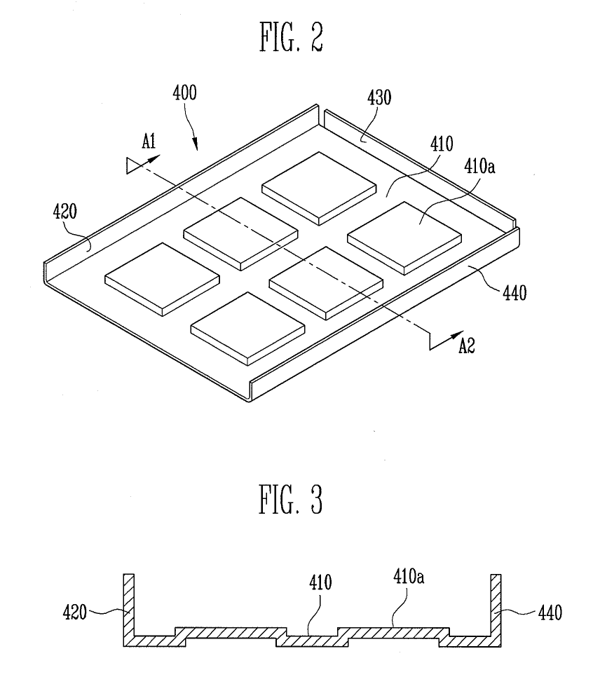

FIG. 2 is a perspective view for showing a bezel according to an embodiment of the present invention. Hereinafter, the bezel according to the embodiment of the present invention will be explained with reference to FIGS. 2 and 3. The lower surface 310 of the bezel of FIG. 1 includes a plane. However, the bezel according to an embodiment provides a structure which can effectively absorb an impact applied to the lower surface. The bezel 400 according to the embodiment of the present invention includes a lower surface 410 and three side walls 420, 430, and 440 extending from the edges of the lower surface and rectangular protrusions 410a are formed in the lower surface 410 by a predetermined interval.

In the illustrated embodiment, a side wall is not formed in one edge of the lower plate of the bezel so that an FPC can be easily provided in the pad section 140, but in other embodiments, the bezel can include four side walls. Further, in certain embodiments, the protrusion 410 can have a circular shape as well as a rectangular shape. The pad section 140 is located in the surface in which a side wall is not formed, and the display panel 100 is accommodated so that the rest of the side surfaces oppose to the side walls 420, 430, and 440 and the support substrate 110 opposes to the protrusions 410a.

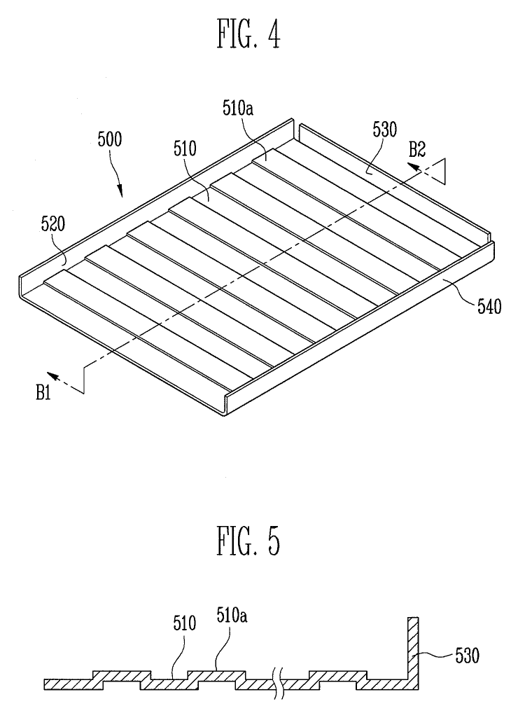

FIG. 4 is a perspective view for explaining a bezel according to an embodiment of the present invention. Hereinafter, the bezel of this embodiment will be described with reference to FIGS. 4 and 5. The bezel according to this embodiment of the present invention includes a lower surface 510 and three side walls 520, 530, and 540. As shown in FIG. 5, protrusions 510 are formed in the lower surface 510 by a predetermined interval. Each of the protrusions 510 has the form of a stripe having a predetermined width. In the illustrated embodiment, a side wall is not formed in one surface of the bezel so that an FPC can be easily provided in the pad section 140, but, in other embodiments the bezel can include four side walls. In certain embodiments, the protrusion 410 is shown so as to have a U-shaped cross-section but can have a curved surface. The pad section 140 is located in the surface in which a side wall is not formed, and the display panel 100 is accommodated so that the rest of the side surfaces oppose to the side walls 520, 530, and 540 and the support substrate 110 opposes to the protrusions 510a.

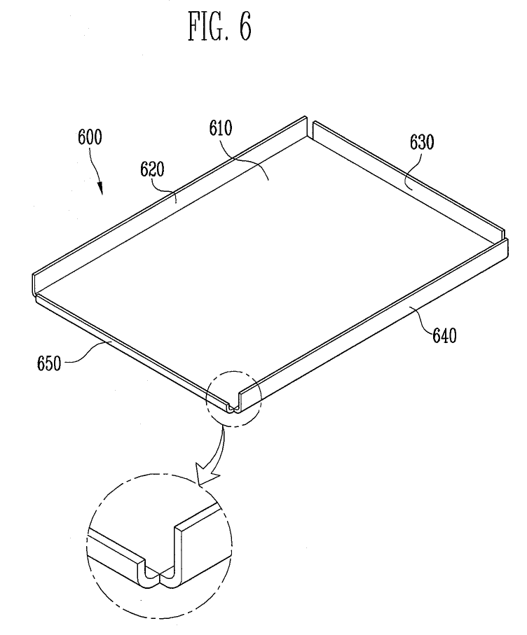

FIG. 6 is a perspective view for explaining a bezel according to an embodiment of the present invention. The bezel according to this embodiment includes a lower surface 610 and four side walls 620, 630, 640, and 640 extending from the edges of the lower surface 610. In the bezel according to this embodiment of the present invention, one side wall 650 is formed in the front surface corresponding to one side surface of the display panel 100 and the height of the side wall 650 is equal to that of the support substrate 110 so that the FPC can be easily provided in the pad section 140 and all side surfaces of the display panel 100 can be protected.

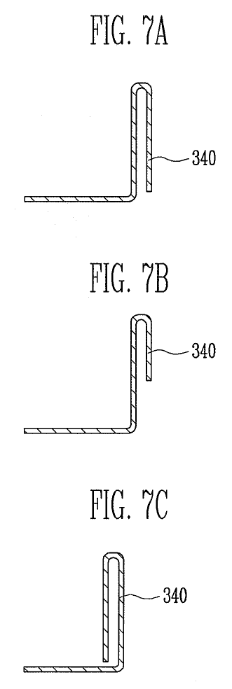

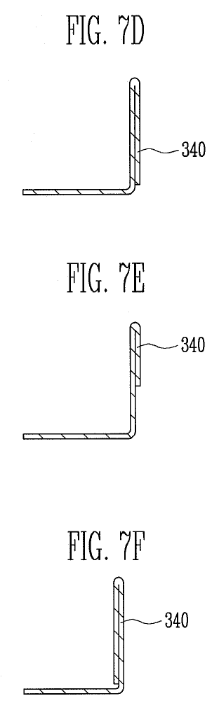

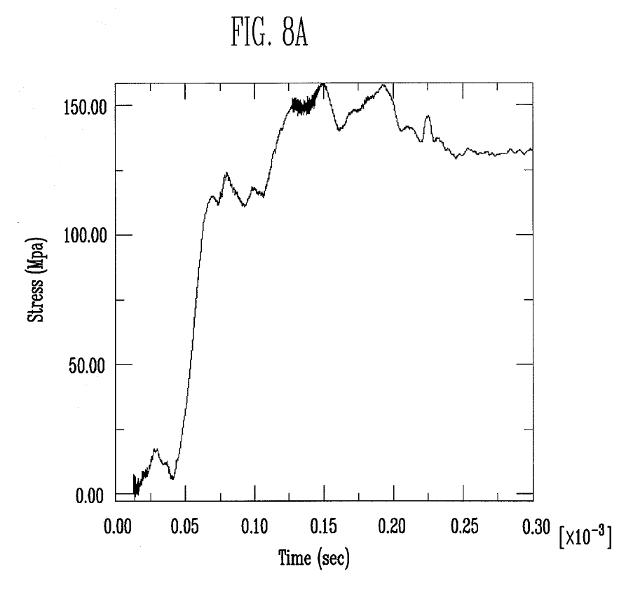

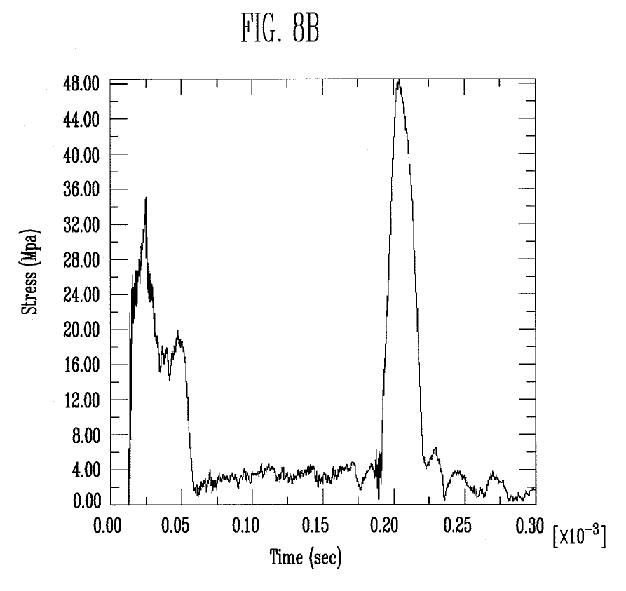

In the above-discussed embodiments, the bezels 300, 400, 500, and 600 shown in FIGS. 1, 2, 4, and 6 have sidewalls of a single wall structure. However, in certain embodiments of the present invention, side wall may be formed to have multiple wall structure so as to provide a structure which can effectively absorb an impact applied to the side walls. FIGS. 7a to 7f show an embodiment of side wall having dual wall structure and the side wall 340 of FIG. 1 will be exemplified.

The side wall of the dual wall structure can be realized by bending the side wall 340. As shown in FIGS. 7a to 7c, the side wall 340 can be bent so that a space is formed between the walls, or as shown in FIGS. 7d to 7f, the side wall 340 can be bent so that the walls contact to each other. Then, the side wall 340 can be bent inwardly or outwardly. Further, the heights of the inner and outer walls can be identical with each other as in FIGS. 7a, 7c, 7d, and 7f, or can be different from each other as in FIGS. 7b and 7e.

Table 1 shows a simulation result which has measured the maximum impact transferred to portions of the display panel in the 1 meter drop test. The table shows the results of case B using a bezel according to an embodiment of the present invention including in which the protrusions are formed on the lower surface and the mold frame and the results of case A of using an exemplary bezel. In the result, in the case of the inorganic encapsulation material 130, the effect is decreased by about 25 percent and in the case of the encapsulating substrate 120, the effect is decreased by about 16.3 percent. Although in the case of the edge of the support substrate 110, the stress is increased by 2.66 percent, since the absolute value of the stress is very small as compared with the encapsulating substrate 120, the influence thereof can be ignored. Then, the reasons for observing the stresses generated at the edges of the substrates 110 and 120 are as follows.

In the case of a glass substrate, many micro-cracks may be generated on a cut surface in the process of cutting the substrate into a predetermined size. Therefore, if the stress is concentrated at the crack portions, the cracks may be easily transferred to the inner side by small stresses as compared with a portion in which a crack is not generated, and thus, the substrate may be easily damaged. Therefore, it is important to observe the stresses generated at the edges of the substrates 110 and 120.

TABLE 1

Maximum
main stress
(MPa)

| | A | B | Effect |
|---|---|---|---|
| Inorganic | 207.6 | 155.71 | Decreased by 24.98 |
| encapsulation | | | percent |
| material | | | |
| Edge of | 147.6 | 123.53 | Decreased by 16.29 |
| encapsulating | | | percent |
| substrate | | | |
| Edge of support | 77.82 | 79.89 | Increased by 2.66 |
| substrate | | | percent |

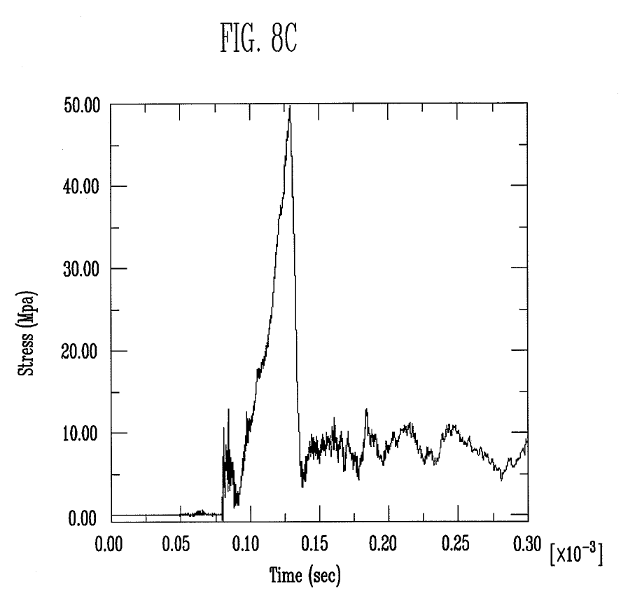

Further, FIG. 8a is a simulation result measuring stresses generated at a pad section in the case in which the exemplary bezel falls toward the pad section. FIG. 8b is a simulation result measuring stresses generated at a pad section in the case in which the bezel having four side walls according to an embodiment of the present invention falls toward the pad section. FIG. 8c is a simulation result measuring stresses generated at a pad section in the case in which the bezel having three side walls according to an embodiment of the present invention falls toward the pad section.

The maximum stress transferred to the substrate in the case of the exemplary bezel has the maximum value of 158.7 MPa (FIG. 8a), and those in the case of the bezels according to an embodiment of the present invention have the maximum values of 48.55 MPa (FIG. 8b) and 49.79 MPa (FIG. 8c), which are decreased by 69.4 percent and 68.6 percent as compared with the exemplary bezel.

As mentioned above, according to the present invention, an impact is absorbed by the mold frame interposed between the side wall of the bezel and the display panel and the protrusions formed on the lower surface of the bezel, effectively decreasing the stress transferred to the display panel. According to the present invention, the stress transferred to the side surface and the lower surface can be decreased, thereby safely protecting the display panel from an impact.

As mentioned above, various embodiments of the present invention is disclosed through the descriptions and the drawings. It would be appreciated by those skilled in the art that changes might be made in the embodiments without departing from the principles and spirit of the invention, the scope of which is defined in the claims and their equivalents.

What is claimed is:

1. An organic light emitting display device comprising:
a display panel comprising a first substrate, a second substrate opposing the first substrate, an array of organic light emitting pixels interposed between the first and second substrates, and an encapsulation material surrounding the array and interconnecting the first substrate and the second substrate, wherein the display panel comprises a first side;
a support frame comprising a lower plate and a plurality of side walls extending from edges of the lower plate, the lower plate and the plurality of side walls defining a space in which the display panel is accommodated, wherein the plurality of side walls comprises a first side wall opposing the first side of the display panel, wherein the first side wall comprises a first wall portion, a second wall portion and a connecting portion interconnecting the first and second wall portions, and wherein the first wall portion is interposed between the second wall portion and the first side of the display panel; and
an intervening frame comprising a first intervening portion interposed between the first wall portion of the first side wall and the first side of the display panel.

2. The device of claim 1, wherein the first intervening portion contacts both the first wall portion of the first side wall and the first side of the display panel.

3. The device of claim 1, wherein the intervening frame is bonded to the support frame.

4. The device of claim 1, wherein the display panel further comprises a second side, wherein the plurality of side walls of the support frame further comprises a second side wall, and wherein the intervening frame further comprises a second intervening portion which is interposed between the second side of the display panel and the second side wall of the support frame.

5. The device of claim 4, wherein the display panel further comprises a third side, wherein the plurality of side walls of the support frame further comprises a third side wall, and wherein the intervening frame further comprises a third intervening portion which is interposed between the third side of the display panel and the third side wall of the support frame.

6. The device of claim 5, wherein the first intervening portion is connected to the second intervening portion, and wherein the first intervening portion is connected to the third intervening portion.

7. The device of claim 6, wherein the second intervening portion comprises two ends opposite to each other, and wherein one end is connected to the first intervening portion and the other end is a free end.

8. The device of claim 1, wherein the first wall portion comprises a first surface opposing the second wall portion, wherein the second wall portion comprises a second surface opposing the first wall portion, and wherein at least a portion of the first surface contacts the second surface.

9. The device of claim 1, wherein the first wall portion comprises a first surface opposing the second wall portion, wherein the second wall portion comprises a second surface opposing the first wall portion, and wherein the first surface does not contact the second surface.

10. The device of claim 1, wherein the first wall portion is directly connected to the lower plate.

11. The device of claim 1, wherein the second wall portion is directly connected to the lower plate.

12. The device of claim 1, wherein the intervening frame comprises a material selected from the group consisting of LCP, ABS, PCABS and PC.

13. The device of claim 1, wherein the support frame comprises a material selected from the group consisting of metal and polymeric resin.

14. The device of claim 1, wherein the encapsulation material comprises a frit.

15. The device of claim 14, wherein the first intervening portion of the intervening frame contacts the frit.

16. The device of claim 1, wherein the display panel comprises a surface opposing the lower plate, and wherein the surface is bonded to the lower plate.

17. A method of making an organic light emitting display device, the method comprising:
providing a support frame, wherein the support frame comprises a lower plate and a plurality of side walls extending from edges of the lower plate, the lower plate and the plurality of side walls defining a space, wherein the plurality of side walls comprises a first side wall opposing the first side of the display panel, and wherein the first side wall comprises a first wall portion, a second wall portion and a connecting portion interconnecting the first and second wall portions;
arranging a display panel so as to be accommodated in the space of the support frame, wherein the display panel comprises a first substrate, a second substrate opposing the first substrate, an array of organic light emitting pixels interposed between the first and second substrates, and an encapsulation material surrounding the array and interconnecting the first substrate and the second substrate, and wherein the display panel is accommodated in the space of the support frame; and
interposing an intervening frame between the display panel and the plurality of side walls.

18. The method of claim 17, wherein interposing comprises forming the intervening frame on at least one of the plurality of the side walls and arranging the support frame and the display panel such that the intervening frame is interposed between the display panel and the plurality of side walls.

19. The method of claim 18, wherein forming comprises placing a curable material on the at least one of the plurality of side walls and curing the curable material.

20. The method of claim 17, wherein the display panel comprises a side, and wherein the intervening frame comprises a portion which contacts both the side of the display panel and one of the plurality of side walls.
